(19) United States
(12) Patent Application Publication
(10) Pub. No.: US 2026/0278614 A1
(43) Pub. Date: Sep. 17, 2026

(54) CUSTOMER MONITORING ASSISTANCE DEVICE, CUSTOMER MONITORING ASSISTANCE METHOD, AND RECORDING MEDIUM

(71) Applicant: NEC Corporation, Tokyo (JP)

(72) Inventor: Natsuki SATO, Tokyo (JP)

(73) Assignee: NEC Corporation, Tokyo (JP)

(21) Appl. No.: 19/471,390

(22) PCT Filed: Apr. 12, 2023
(86) PCT No.: PCT/JP2023/014840

§ 371 Date: Oct. 1, 2025

(51) Int. Cl. G06Q 20/40; G06Q 20/18; G06Q 20/20; G06V 40/20

(52) U.S. Cl. CPC G06Q 20/4016; G06Q 20/18; G06Q 20/209; G06V 40/28

(57) ABSTRACT

This customer monitoring assistance device includes, an acquisition unit for acquiring a moving image obtained by imaging the movement of the hands of a customer that operates a self-checkout register; a determination unit for determining, on the basis of the imaged customer hand movement, whether the customer is possibly performing a fraudulent act or is unfamiliar with the operation of the self-checkout register; and an output unit for outputting different contents according to the determination result. If it was determined that there is a possibility that the customer is performing a fraudulent act, the output unit outputs a notification indicating that there is a customer who may be performing a fraudulent act. When it is determined that the customer is unfamiliar with the operation, the output unit outputs an instruction to assist the customer determined to be unfamiliar with the operation.

### TECHNICAL FIELD

The present disclosure relates to a customer monitoring assistance device, a customer monitoring assistance method, and a recording medium.

### BACKGROUND ART

In stores such as supermarkets, self-checkout terminals have been introduced. A customer who uses a store registers products and makes payment by him/herself. However, at a time of using a self-checkout terminal, the customer may not know a terminal operation and may be in trouble. The customer may perform a fraudulent act such as shoplifting.

In view of the above, PTL 1 discloses an invention of a checkout system that makes notification for calling for a salesclerk when a fraudulent act of a customer is detected or difficulty of the customer in the operation is detected.

### CITATION LIST

### Patent Literature

PTL 1: JP 2021-157420 A

### SUMMARY OF INVENTION

### Technical Problem

If the same notification is issued for the case where a fraudulent act of the customer is detected and for the case where the difficulty of the customer in the operation is detected, it may be difficult for the salesclerk to take an appropriate action.

An object of the present disclosure is to provide a customer monitoring assistance device, a customer monitoring assistance method, and a recording medium capable of prompting an appropriate response according to a situation of a customer.

### Solution to Problem

In order to solve the problem described above, a customer monitoring assistance device according to the present disclosure includes an acquisition means for obtaining a moving image obtained by capturing a movement of a hand of a customer who operates a self-checkout terminal, a determination means for determining whether the customer has a possibility of performing a fraudulent act or is unfamiliar with an operation of the self-checkout terminal based on the movement of the hand of the customer, and an output means for outputting different content depending on a determination result.

In order to solve the problem described above, a customer monitoring assistance method according to the present disclosure includes obtaining a moving image obtained by capturing a movement of a hand of a customer who operates a self-checkout terminal, determining whether the customer has a possibility of performing a fraudulent act or is unfamiliar with an operation of the self-checkout terminal based on the movement of the hand of the customer, and outputting different content depending on a determination result.

In order to solve the problem described above, a recording medium according to the present disclosure stores a customer monitoring assistance device program for causing a computer to perform a process including a step of obtaining a moving image obtained by capturing a movement of a hand of a customer who operates a self-checkout terminal, a step of determining whether the customer has a possibility of performing a fraudulent act or is unfamiliar with an operation of the self-checkout terminal based on the movement of the hand of the customer, and a step of outputting different content depending on a determination result.

### Advantageous Effects of Invention

According to the present disclosure, an appropriate response according to a situation of a customer may be prompted.

### BRIEF DESCRIPTION OF DRAWINGS

FIG. 1 is a block diagram illustrating a configuration of a customer monitoring assistance system according to the present invention.

FIG. 2 is a block diagram illustrating a configuration of a customer monitoring assistance device according to the present invention.

FIG. 3 is a diagram illustrating an exemplary screen displayed on a salesclerk terminal of the customer monitoring assistance system according to the present invention.

FIG. 4 is a diagram illustrating an exemplary paper receipt printed by the customer monitoring assistance system according to the present invention.

FIG. 5 is a diagram illustrating an exemplary display screen of a self-checkout terminal in the customer monitoring assistance system according to the present invention.

FIG. 6 is a flowchart illustrating a processing operation of the customer monitoring assistance device according to the present invention.

FIG. 7 is a block diagram illustrating a configuration of the customer monitoring assistance device according to the present invention.

FIG. 8 is a flowchart illustrating a processing operation of the customer monitoring assistance device according to the present invention.

FIG. 9 is a diagram illustrating an exemplary hardware configuration of the customer monitoring assistance device according to the present invention.

### EXAMPLE EMBODIMENT

### First Example Embodiment

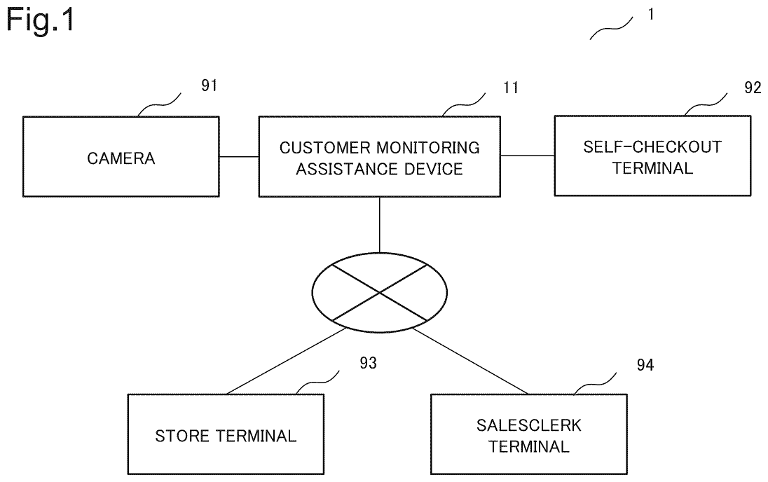

FIG. 1 is a diagram illustrating an exemplary configuration of a customer monitoring assistance system 1 including a customer monitoring assistance device 11. The customer monitoring assistance device 11, a camera 91, a self-checkout terminal 92, a store terminal 93, and a salesclerk terminal 94 are connected to the customer monitoring assistance system.

First, the self-checkout terminal 92 will be described. The self-checkout terminal 92 is a register terminal that allows a customer who uses a store to perform accounting including registration and payment of product information. The customer needs to operate the self-checkout terminal 92 by him/herself. The customer monitoring assistance device 11 and the self-checkout terminal 92 are connected by a wired or wireless network. The customer monitoring assistance device 11 may be included in a function of the self-checkout terminal 92.

The self-checkout terminal 92 includes a display screen (not illustrated). The customer is enabled to confirm contents displayed on the display screen. The display screen is a touch panel, and the customer can operate the self-checkout terminal 92 by touching the display on the screen.

The camera 91 is a camera that captures hand movements of the customer who uses the self-checkout terminal 92. While the customer performs accounting using the self-checkout terminal 92, the camera 91 captures hand movements of the customer. For example, the customer performs scanning operation of product identification information to register product information. The product identification information is, for example, a bar code attached to the product. The camera 91 captures hand movements of the customer performing scanning. In addition, for example, the camera 91 captures hand movements of the customer operating the self-checkout terminal 92. The camera 91 captures hand movements of the customer when the customer inserts cash or a credit card to make payment. The hand movements of the customer to be captured by the camera 91 are not limited to the above. The camera 91 captures a series of hand movements from the start of the accounting to the end of the accounting by the customer. The customer monitoring assistance device 11 and the camera 91 are connected by a wired or wireless network. When the customer monitoring assistance device 11 is included in the self-checkout terminal 92, the self-checkout terminal 92 and the camera 91 may be connected by a wired or wireless network. The number of the cameras 91 is not limited to one. The customer monitoring assistance system 1 may include a plurality of the cameras 91.

The store terminal 93 is, for example, a terminal installed in the backyard of the store. The installation place of the store terminal 93 is not limited to the backyard. It only needs to be installed at a location that may be checked by a salesclerk. The store terminal 93 receives notification or an instruction output from the customer monitoring assistance device 11. Then, the store terminal 93 displays the notification or instruction. The displayed notification or instruction may be checked by the salesclerk. The number of the store terminals 93 to be installed is not limited to one. For example, the store may install the required number of the store terminals 93 depending on a size or staffing of the store. The customer monitoring assistance device 11 and the store terminal 93 may be connected by a wired or wireless network.

The salesclerk terminal 94 is a portable terminal carried by each of salesclerks of the store. The salesclerks may include, for example, a person who performs duties of monitoring the inside of the store, such as a security staff. The salesclerk terminal 94 receives the notification or instruction output from the customer monitoring assistance device 11. Then, the salesclerk terminal 94 displays the notification or instruction on the screen. The notification or instruction displayed on the screen may be checked by the salesclerk. The number of the salesclerk terminals 94 is not limited to one. All the salesclerks of the store may carry the salesclerk terminal 94. Only a limited number of the salesclerks may carry the salesclerk terminal 94. While the customer monitoring assistance device 11 and the salesclerk terminal 94 are wirelessly connected as illustrated in FIG. 1, it is not limited to this example.

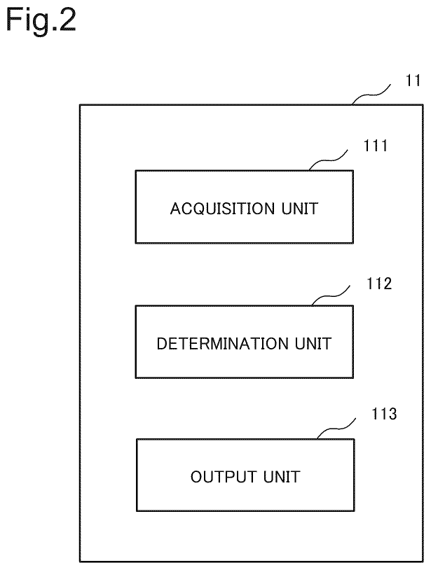

Next, the customer monitoring assistance device 11 will be described with reference to FIG. 2. FIG. 2 is a block diagram illustrating a configuration of the customer monitoring assistance device 11. The customer monitoring assistance device 11 includes an acquisition unit 111 that obtains moving images obtained by capturing hand movements of the customer who operates the self-checkout terminal 92, a determination unit 112 that determines, based on the hand movements of the customer, whether the customer may be performing a fraudulent act or is unfamiliar with the operation of the self-checkout terminal 92, and an output unit 113 that outputs different contents for individual persons.

The acquisition unit 111 is an aspect of an acquisition means that obtains moving images obtained by capturing hand movements of the customer who operates the self-checkout terminal 92. The acquisition unit 111 obtains, from the camera 91, moving images of hand movements of the customer captured by the camera 91. The camera 91 captures images at an angle of view at which the face of the customer does not appear in the moving images. The face of the customer may appear in the moving images.

The determination unit 112 is an aspect of a determination means that determines, based on the hand movements of the customer, whether the customer may be performing a fraudulent act or is unfamiliar with the operation of the self-checkout terminal 92. The determination unit 112 recognizes the hand movements of the customer captured in the moving images using, for example, image recognition. A publicly known technique is used for the image recognition. Then, the determination unit 112 determines whether the customer may be performing a fraudulent act or is unfamiliar with the operation of the self-checkout terminal 92. Here, examples of the fraudulent act include shoplifting. The determination by the determination unit 112 is made in real time during, for example, the accounting by the customer. The determination unit 112 only needs to make determination before the accounting by the customer is complete. As another example of the timing at which the determination unit 112 makes determination, the determination may be made after the accounting by the customer is complete.

The case of being unfamiliar with the operation of the self-checkout terminal 92 includes the following cases. For example, there is a case where a customer, who is not accustomed to using the self-checkout terminal 92, does not know how to operate the self-checkout terminal 92. Even a customer who is accustomed to using the self-checkout terminal 92 may have difficulty in the operation due to an unusual situation. Examples of the unusual situation include a case of using a payment method different from a usual case. Moreover, a screen not usually used may be displayed on the screen due to an erroneous operation.

Moreover, even a customer who knows how to operate the self-checkout terminal 92 may have difficulty in accounting. Also in that case, it is assumed to be the case of being unfamiliar with the operation of the self-checkout terminal 92. Specific examples thereof include a case where the customer has difficulty in scanning product identification information to register product information. An exemplary cause thereof is considered to be that the position of the product identification information attached to the product is unknown. Then, if the customer fails to find the product identification information attached to the product, assistance by the salesclerk may be required. This is because the salesclerk may be more familiar with the position of the product identification information than the customer.

Moreover, as a situation in which the customer has difficulty in scanning the product identification information, a situation may be considered in which a product with no product identification information attached is to be purchased due to a mistake of the salesclerk. A situation may also be considered in which product registration needs to be performed by a method not using the product identification information. In those situations, assistance by the salesclerk may be required. As described above, being unfamiliar with the operation of the self-checkout terminal 92 indicates a person who needs assistance in the operation. Conceivable examples of the method for assisting the operation include a method of operational assistance by the salesclerk, a method of operational assistance by screen display, and a method of operational assistance by audio output.

Next, a determination method by the determination unit 112 will be described. Here, the determination method is a criterion for determination to be used by the determination unit 112 to make determination. The determination unit 112 uses hand movements of the customer at a time of registering product information to determine whether the customer may be performing a fraudulent act. At the time of registering the product information, the customer scans the product identification information attached to the product. Then, if there is a product that has not been subject to the scanning operation, the determination unit 112 may determine that the customer may be performing a fraudulent act. The fact that there is a product that has not been subject to the scanning operation means that, for example, the customer moves an unregistered product to a table for placement of registered products without performing the scanning. If there is a product that has been subject to a pretended scanning operation, the determination unit 112 may determine that the customer may be performing a fraudulent act. The fact that there is a product that has been subject to a pretended scanning operation means that, for example, the customer pretends to perform the scanning operation and moves an unregistered product to the table for placement of registered products.

In addition, at the time of registering the product information, the customer may operate the self-checkout terminal 92 to directly register the product information in the self-checkout terminal 92. Specifically, the customer registers the product information by pressing a button included in the self-checkout terminal 92. In addition, the customer directly registers the product information in the self-checkout terminal 92 by operating the display screen included in the self-checkout terminal 92. At this time, if there is a product for which the hand of the customer has not operated the self-checkout terminal 92, the determination unit 112 may determine that the customer may be performing a fraudulent act. The fact that there is a product for which the hand of the customer has not operated the self-checkout terminal 92 means that the customer moves an unregistered product for which no operation of the self-checkout terminal has been performed to the table for placement of registered products. As described above, the determination unit 112 determines whether the customer may be performing a fraudulent act from the hand movements of the customer at the time of registering the product information.

Next, determination as to whether the customer is unfamiliar with the operation of the self-checkout terminal 92, which is made by the determination unit 112 based on hand movements, will be described. For example, the determination unit 112 determines whether the customer is unfamiliar with the operation of the self-checkout terminal 92 based on whether the hand of the customer performs the same operation for equal to or more than a predetermined time. Performing the same operation for equal to or more than a predetermined time may be, for example, a case where the hand of the customer continues to stop in front of the self-checkout terminal 92. The hand of the customer may continue to stop because the customer does not know the operation of the self-checkout terminal 92. In view of the above, the determination unit 112 determines that the customer is unfamiliar with the operation of the self-checkout terminal 92 when the hand of the customer is stationary for a predetermined time with respect to the self-checkout terminal 92. Here, the fact that the hand of the customer is stationary means that, for example, the hand is kept at the same position. The predetermined time is, for example, a value determined in advance according to the situation of the store.

The case of performing the same operation for equal to or more than a predetermined time further includes a case where the hand of the customer performs an operation of searching for the product identification information attached to the product for equal to or more than the predetermined time. At this time, it is considered that the customer is in trouble without finding the product identification information, that is, the customer needs assistance in the operation. In view of the above, the determination unit 112 determines that the customer is a person who is unfamiliar with the operation of the checkout terminal when the hand of the customer performs the operation of searching for the product identification information attached to the product for equal to or more than the predetermined time.

While the determination as to whether the customer may be performing a fraudulent act or is unfamiliar with the operation of the self-checkout terminal 92, which is made by the determination unit 112 based on the hand movements of the customer, has been described above, it is not limited to the example described above.

The output unit 113 is an aspect of an output means that outputs different contents depending on a determination result.

An exemplary output will be described. When the determination unit 112 determines that the customer may be performing a fraudulent act, the output unit 113 outputs notification indicating that there is a customer who may be performing a fraudulent act. When the determination unit 112 determines that the customer is unfamiliar with the operation, the output unit 113 outputs an instruction to support the customer determined to be unfamiliar with the operation. The instruction includes a determination result that the customer is determined to be unfamiliar with the operation. As described above, the output differs depending on the determination result.

An output destination of the notification or instruction is, for example, the store terminal 93 or the salesclerk terminal 94. The output unit 113 outputs the notification or instruction to at least one of the store terminal 93 or the salesclerk terminal 94. Then, the store terminal 93 or the salesclerk terminal 94 receives the notification or instruction. Then, the store terminal 93 or the salesclerk terminal 94 displays the received notification or instruction on the screen. The salesclerk may check the notification or instruction. Here, the output unit 113 may output it to a plurality of output destinations. That is, the output unit 113 may output it to a plurality of different terminals. The output unit 113 may output it to a plurality of terminals of the same type.

The notification or instruction described above may include information that may identify the self-checkout terminal 92. A store in which a plurality of self-checkout terminals is installed will be described as an example. When there is a plurality of the self-checkout terminals 92, the salesclerk needs to identify the self-checkout terminal used by the customer determined to be possibly performing a fraudulent act or unfamiliar with the operation of the self-checkout terminal 92. Thus, the notification or instruction output from the output unit 113 includes information that may identify the self-checkout terminal 92. Examples of the information that may identify the self-checkout terminal 92 include a number assigned to the self-checkout terminal 92.

Moreover, the notification indicating that there is a customer who may be performing a fraudulent act may include time at which the determination that the customer may be performing a fraudulent act is made. The instruction to support the customer determined to be unfamiliar with the operation may include time at which the determination that the customer is unfamiliar with the operation of the self-checkout terminal 92 is made.

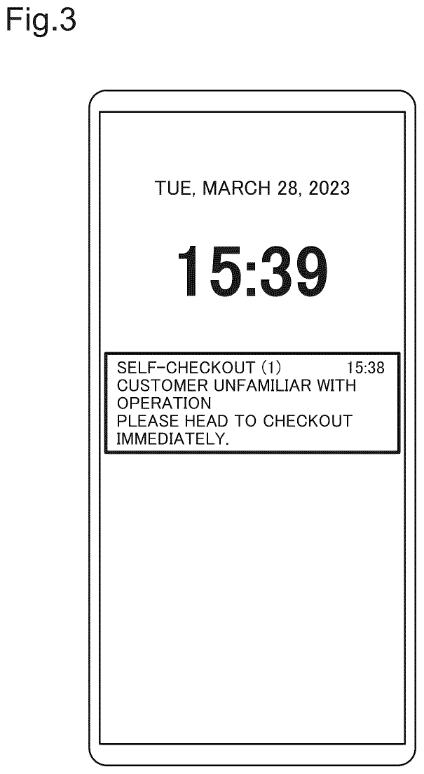

Here, FIG. 3 is a diagram illustrating an exemplary screen displayed on the salesclerk terminal 94. FIG. 3 is an exemplary screen displayed on the salesclerk terminal 94 when the determination unit 112 determines that the customer is unfamiliar with the operation of the self-checkout terminal 92. Referring to FIG. 3, together with a determination result that the customer is determined to be unfamiliar with the operation, an instruction to support the customer determined to be unfamiliar with the operation is displayed on the screen of the salesclerk terminal 94. Then, a number assigned to the self-checkout terminal 92 is also displayed as information that may identify the self-checkout terminal 92. Moreover, the time at which the customer is determined to be unfamiliar with the operation of the self-checkout terminal 92 is also displayed. The display method in the salesclerk terminal 94 is not limited thereto. The display position or the display format on the screen may be changed as appropriate. The expression for presenting the determination result and instruction is also not limited thereto. It is sufficient if the salesclerk is enabled to check the determination result that the customer is unfamiliar with the operation and the instruction to support the customer determined to be unfamiliar with the operation.

The output unit 113 may change the output destination depending on the determination result. As an example, a case where the output unit 113 performs an output to the salesclerk terminal 94 in a store where a security staff is present will be described. In the store where the security staff is present, the output unit 113 outputs notification to the salesclerk terminal 94 carried by the security staff when the customer is determined to be possibly performing a fraudulent act. This notification indicates that there is a customer who may be performing a fraudulent act. When the customer is performing a fraudulent act, there may be a risk if a salesclerk other than the security staff takes action. It is also considered that the security staff is more familiar with a method of dealing with a fraudulent act of a customer than other salesclerks.

Meanwhile, when the customer is determined to be unfamiliar with the operation of the self-checkout terminal 92, the output unit 113 outputs an instruction to support the customer to the salesclerk terminal 94 carried by a salesclerk other than the security staff. A salesclerk other than the security staff may be more familiar with the operation of the self-checkout terminal 92. The instruction may be output to the salesclerk terminal 94 carried by the salesclerk closest to the target self-checkout terminal 92. At this time, the output unit 113 does not output the instruction to the salesclerk terminals 94 carried by other salesclerks. The target self-checkout terminal 92 is the self-checkout terminal 92 used by the customer determined to be unfamiliar with the operation of the self-checkout terminal 92.

For example, the output unit 113 identifies the salesclerk terminal 94 closest to the target self-checkout terminal 92 based on positional information of the salesclerk terminal 94. Then, the output unit 113 outputs notification to the identified salesclerk terminal 94. In addition, for example, when there is a salesclerk in charge of customer support in operation of the self-checkout terminal 92, the output unit 113 may output the instruction to the salesclerk terminal 94 carried by the salesclerk.

Moreover, when the output unit 113 performs an output to a plurality of output destinations in the case where the customer is determined to be possibly performing a fraudulent act, output contents may be changed depending on the output destination. When the output unit 113 performs an output to a plurality of output destinations in the case where the customer is determined to be unfamiliar with the operation of the self-checkout terminal 92, output contents may be changed depending on the output destination.

First, the case where the customer is determined to be possibly performing a fraudulent act will be described. In this case, for example, contents of the notification to be output to the salesclerk terminal 94 carried by the security staff may be made different from contents of the notification to be output to the salesclerk terminal 94 carried by a salesclerk other than the security staff. The notification to be output to the salesclerk terminal 94 carried by the security staff may include an instruction to head to the self-checkout terminal 92 used by the customer together with the determination result that the customer may be performing a fraudulent act. In that case, the output unit 113 transmits notification indicating the determination result that the customer may be performing a fraudulent act to the salesclerk terminal 94 carried by a person other than the security staff. Meanwhile, the output unit 113 does not include the instruction to head to the self-checkout terminal 92 used by the customer in the output to the salesclerk terminal 94 carried by the person other than the security staff. The output destination and the output contents are not limited thereto.

Next, the case where the customer is determined to be unfamiliar with the operation of the self-checkout terminal 92 will be described. As an example, the output unit 113 outputs an instruction to the salesclerk terminal 94 and to the store terminal 93. The output unit 113 outputs, to the salesclerk terminal 94, a determination result that the customer is unfamiliar with the operation of the self-checkout terminal 92 and an instruction to head to the self-checkout terminal 92 used by the customer. Then, the output unit 113 may output, to the store terminal 93, the determination result that the customer is unfamiliar with the operation of the self-checkout terminal 92 and an instruction to patrol the area around the self-checkout terminal 92. The contents of the instruction output to the store terminal 93 are not limited to the above. It is sufficient if the contents of the instruction output from the output unit 113 to the salesclerk terminal 94 are different from the contents of the instruction output to the store terminal 93. The output destination and the output contents are examples.

Other examples of the output destination to which the output unit 113 performs an output include a light (not illustrated) provided at the self-checkout terminal 92. The light may be provided outside the self-checkout terminal 92. In that case, the self-checkout terminal 92 and the light are connected by a wired or wireless network. Alternatively, the customer monitoring assistance device 11 and the light may be connected by a wired or wireless network.

The output unit 113 may perform an output to a different output destination when a light is included in the output destination of the output unit 113. In the following descriptions, it is assumed that a light is provided at the self-checkout terminal 92.

First, when the customer is determined to be unfamiliar with the operation of the self-checkout terminal 92, the output unit 113 outputs an instruction to turn on the light to the self-checkout terminal 92. Then, the self-checkout terminal 92 receives the instruction output from the output unit 113. Then, the self-checkout terminal 92 turns on the light. The salesclerk may confirm that the light provided at the self-checkout terminal 92 is turned on. Then, the salesclerk may head to the self-checkout terminal 92 in which the light is turned on, and give operational assistance to the customer. At this time, the output unit 113 may also output an instruction to the salesclerk terminal 94 or the store terminal 93.

Meanwhile, when the customer is determined to be possibly performing a fraudulent act, the output unit 113 outputs the notification to the store terminal 93 or to the salesclerk terminal 94 described above. On the other hand, the output unit 113 does not output an instruction to turn on the light to the self-checkout terminal 92. This is because, if the light is turned on, the customer him/herself may recognize that the customer is determined to have a possibility of performing a fraudulent act. In view of the above, the output unit 113 does not output the instruction to turn on the light to the self-checkout terminal 92, whereby the customer is not aware of the determination result.

In this manner, the output unit 113 may perform an output to different output destinations depending on the determination result.

The output when the customer is determined to have a possibility of performing a fraudulent act will be further described. When the customer is determined to be unfamiliar, the output unit 113 does not perform the output to be described below.

The output unit 113 may also output an instruction to print, on a receipt, information that may be used to identify a potential fraudulent act. A bar code, a two-dimensional code, an identifier (ID), or a mark is printed on the receipt as information that may be used to identify a potential fraudulent act. Examples of the two-dimensional code include a QR code (registered trademark). The ID is assigned to a moving image obtained by capturing the customer determined by the determination unit 112. That is, the ID identifies the moving image of the customer who has performed accounting. Details of the bar code, QR code, ID, or mark will be described later. The information that may be used to identify a potential fraudulent act is not limited thereto. The output unit 113 outputs an instruction to print the information that may be used to identify a potential fraudulent act on the receipt of the customer determined to have a possibility of performing a fraudulent act.

Here, the receipt may be a paper receipt, or may be an electronic receipt. In the case of the paper receipt, the output unit 113 outputs the instruction regarding the printing on the receipt to, for example, a receipt printing device (not illustrated). The customer monitoring assistance device 11 is connected to the printing device by a wired or wireless network. When the receipt printing device is included in the self-checkout terminal 92, the output unit 113 outputs the instruction to the self-checkout terminal 92. Then, the printing device prints, on the receipt, the information that may be used to identify a potential fraudulent act based on the instruction from the output unit 113.

In the case where the receipt is an electronic receipt, the output unit 113 outputs an instruction to display the information that may be used to identify a potential fraudulent act at a predetermined position on the electronic receipt. Then, the output unit 113 outputs the instruction to, for example, a customer terminal (not illustrated). The output destination is not limited to the customer terminal. The output destination may be any terminal as long as the customer can confirm the contents of the receipt.

The salesclerk may check the information that may be used to identify a potential fraudulent act printed on the receipt. Then, the salesclerk may grasp the determination result of the customer.

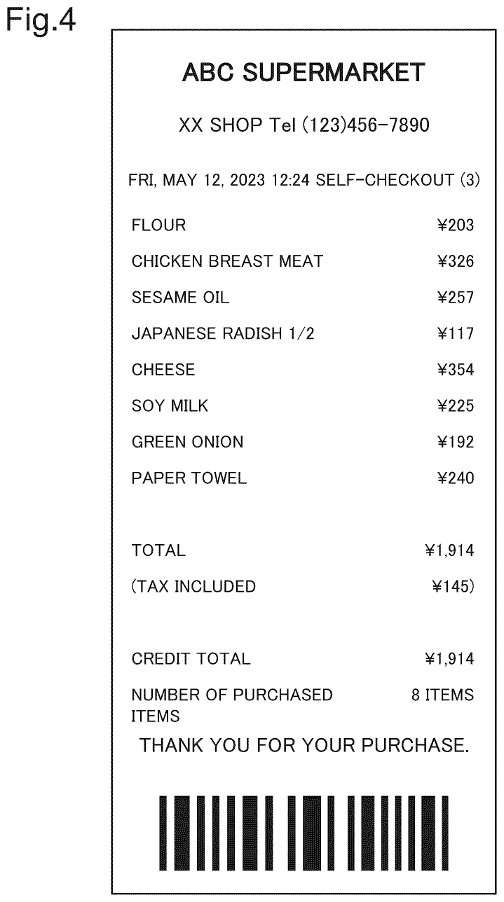

FIG. 4 is a diagram illustrating an example of the paper receipt printed by the printing device. Referring to FIG. 4, a bar code is printed in the lower part of the receipt. The bar code illustrated in FIG. 4 is the information that may be used to identify a potential fraudulent act. The position at which the information that may be used to identify a potential fraudulent act is printed is not limited thereto.

In addition to the information that may be used to identify a potential fraudulent act, information regarding the store, and information regarding the accounting of the customer may be printed on the receipt. Referring to FIG. 4, a shop name, a branch name, and a telephone number are printed as the information regarding the store. Product names, prices of products, the total price, and the number of purchased items are also printed as the information regarding the accounting of the customer. The information to be printed is not limited thereto. Necessary information is printed depending on the store or accounting contents.

When the customer is determined to have a possibility of performing a fraudulent act, the determination unit 112 stores, in a memory, moving images for a predetermined time before and after the moment at which the customer may be performing a fraudulent act. The memory may be included in the customer monitoring assistance device 11, or may be an external memory connected to the outside of the customer monitoring assistance device 11 by a wired or wireless network. At this time, the determination unit 112 assigns an ID to the moving image. Then, as information indicating the ID, the information that may be used to identify a potential fraudulent act is printed on the receipt. The determination unit 112 may store, together with the moving image, information regarding the time at which the customer is determined to have a possibility of performing a fraudulent act.

Then, the salesclerk may check the moving images for the predetermined time before and after the moment at which the customer is determined to have a possibility of performing a fraudulent act. The salesclerk may also check the information regarding the time at which the customer is determined to have a possibility of performing a fraudulent act.

For example, the case will be described in which the information that may be used to identify a potential fraudulent act is a printed bar code or QR code. The salesclerk reads the information that may be used to identify a potential fraudulent act using a reading device (not illustrated) connected to the salesclerk terminal 94 or to the self-checkout terminal 92. Then, the output unit 113 obtains, from the reading device, the information that may be used to identify a potential fraudulent act. Then, the output unit 113 reads, from the memory, the moving image to which the ID is assigned indicated by the information that may be used to identify a potential fraudulent act. The output unit 113 outputs an instruction to display the moving image read from the memory on the display screen included in the salesclerk terminal 94 or in the self-checkout terminal 92. The salesclerk terminal 94 or the self-checkout terminal 92 that has received the instruction to display the moving image from the output unit 113 displays the moving image on the screen. The salesclerk may check the displayed moving image. When the time information described above is stored together with the moving image, the output unit 113 reads the moving image and the time information. Then, the output unit 113 may output an instruction to display the moving image and the time information on the display screen.

A gate (not illustrated) may be installed near the area where the self-checkout terminal 92 is installed. The gate may be provided with a reading device (not illustrated) for customer identification information. The gate may be provided with a display device (not illustrated) for displaying the moving image and the time information. The gate may be installed at an exit of the store. The place to install the gate is not limited to the above. The gate only needs to be installed at a location through which the customer after accounting may pass.

With the gate being installed, the customer needs to pass the gate after the accounting is complete. Then, when the customer passes through the gate, the salesclerk checks the receipt of the customer. At this time, the salesclerk may check presence or absence of the information that may be used to identify a potential fraudulent act. Moreover, when the information that may be used to identify a potential fraudulent act is printed on the receipt of the customer, the salesclerk may check the moving image.

The customer him/herself may read the information that may be used to identify a potential fraudulent act. That is, the customer reads the information that may be used to identify a potential fraudulent act using the reading device.

In the case where the information that may be used to identify a potential fraudulent act is a printed bar code or QR code, the bar code or QR code may be printed on the receipts of all the customers. In that case, the salesclerk may check the determination result from the reading result.

When the customer is determined to be possibly performing a fraudulent act, the determination unit 112 stores the determination result that the customer may be performing a fraudulent act together with the moving image. On the other hand, when the customer is not determined to have a possibility of performing a fraudulent act by the end of the accounting, the determination unit 112 assigns an ID to the determination result and stores it. At this time, the determination unit 112 stores no moving image. Then, the output unit 113 outputs an instruction to print, on the receipt, the information that may be used to identify a potential fraudulent act as the information indicating the ID.

The salesclerk reads the information that may be used to identify a potential fraudulent act using the reading device. The output unit 113 obtains, from the reading device, the information that may be used to identify a potential fraudulent act. Then, the output unit 113 reads the moving image or the determination result. An ID indicated by the information that may be used to identify a potential fraudulent act is assigned to the moving image or the determination result. Then, the output unit 113 outputs an instruction to display the moving image or the determination result. The output destination is, for example, the display screen included in the salesclerk terminal 94 or in the self-checkout terminal 92, or the display device installed at the gate.

The salesclerk checks the displayed determination result. Then, the salesclerk may check whether the customer is determined to have a possibility of performing a fraudulent act.

Here, the customer him/herself may read the information that may be used to identify a potential fraudulent act. That is, the customer reads the information that may be used to identify a potential fraudulent act using the reading device. The output unit 113 may output notification when the customer who has performed the reading is a customer determined to have a possibility of performing a fraudulent act. In that case, the salesclerk may deal with the customer determined to have a possibility of performing a fraudulent act. On the other hand, when the customer determined to have no possibility of performing a fraudulent act passes through the gate, no action needs to be taken for the customer.

Next, the case will be described in which an ID is printed as the information that may be used to identify a potential fraudulent act. The output unit 113 assigns an ID to the determination result, moving image, or time information described above. Then, the determination unit 112 stores the determination result, the moving image, or the time information in the memory. Then, the output unit 113 outputs an instruction to print the ID on the receipt. The determination result, the moving image, or the time information may be all stored as appropriate.

The salesclerk inputs the ID using the salesclerk terminal 94 or an input device (not illustrated) included in the self-checkout terminal 92. The output unit 113 obtains the input ID from the input device. The output unit 113 reads the determination result, moving image, or time information to which the ID is assigned from the memory. Then, the output unit 113 outputs an instruction to display the determination result, the moving image, or the time information on the display screen included in the salesclerk terminal 94 or in the self-checkout terminal 92. The salesclerk terminal 94 or the self-checkout terminal 92 displays the determination result, the moving image, or the time information on the screen. The salesclerk may check the displayed determination result, moving image, or time information. The output unit 113 may output an instruction to display any two of the determination result, the moving image, or the time information as appropriate. The output unit 113 may output an instruction to display the determination result, the moving image, and the time information.

Also in the case where an ID is printed as the information that may be used to identify a potential fraudulent act, the gate may be installed in the store. The gate is provided with a device that allows the salesclerk to input an ID, and a display device.

The ID may be printed on the receipts of all the customers. At this time, the output unit 113 reads at least the determination result to which the ID input by the salesclerk is assigned. Then, the output unit 113 outputs an instruction to display the determination result on the display device. The salesclerk checks the determination result displayed on the display device. Then, the salesclerk may grasp whether the customer is determined to have a possibility of performing a fraudulent act.

The case will be described in which a mark is printed as the information that may be used to identify a potential fraudulent act. At this time, a mark and a determination result are associated with each other in advance. A list of marks and determination results, which are associated with each other in advance, is stored in the memory, for example. Then the output unit 113 reads the mark relevant to the determination result by the determination unit 112. Then, the output unit 113 outputs an instruction to print the mark on the receipt.

For example, the output unit 113 outputs an instruction to print a triangle on the receipt of the customer determined by the determination unit 112 to have a possibility of performing a fraudulent act. In that case, the mark of the triangle is associated with the determination result that the customer is determined to have a possibility of performing a fraudulent act.

On the other hand, the output unit 113 outputs an instruction to print a quadrangle on the receipt of the customer determined by the determination unit 112 to have no possibility of performing a fraudulent act. In that case, the mark of the quadrangle is associated with the determination result that the customer is determined to have no possibility of performing a fraudulent act. The output unit 113 may not output an instruction to print a mark on the receipt of the customer not determined to have a possibility of performing a fraudulent act.

As described above, the presence or absence of the printing of the mark on the receipt or the mark to be printed differs depending on the determination result by the determination unit 112. In addition, the salesclerk knows the determination result associated with the mark in advance. Thus, the salesclerk may check whether the customer is a customer determined to have a possibility of performing a fraudulent act by checking the printing of the mark on the receipt of the customer.

The shape of the mark is not limited to the above. It is sufficient if the information that may be used to identify a potential fraudulent act is associated with the determination result in advance. Thus, the information that may be used to identify a potential fraudulent act may be a number. That is, the number may be associated with the determination result in advance. A specific example will be described. It is assumed that the determination result that a fraudulent act may be performed is associated with 1, and the determination result that a possibility of performing a fraudulent act is not determined is associated with 2. In that case, when the customer is determined to be possibly performing a fraudulent act, the output unit 113 outputs an instruction to print the number 1 on the receipt. On the other hand, when the customer is not determined to be possibly performing a fraudulent act, the output unit 113 outputs an instruction to print the number 2 on the receipt. The number is not limited to the above. The position at which the mark or the number is printed may be any position on the receipt. The size of the mark or the number may be any size. The mark or the number is displayed in a format that may be recognized by the customer and the salesclerk.

While the description regarding the output of the instruction to print, on the receipt, the information that may be used to identify a potential fraudulent act by the output unit 113 has been given above, it is not limited to the example described above.

A different example of the output of the output unit 113 when the customer is determined to be possibly performing a fraudulent act will be described. The output unit 113 may output an instruction to display a moving image obtained by capturing hand movements of the customer operating the self-checkout terminal 92 on the display screen of the self-checkout terminal 92. This moving image is a moving image obtained by the acquisition unit 111 from the camera 91. With the moving image being displayed on the display screen of the self-checkout terminal 92 operated by the customer, the customer is enabled to grasp that the hand movements of him/herself are being captured. When the customer grasps that the hand movements are being captured, the customer may give up performing a fraudulent act.

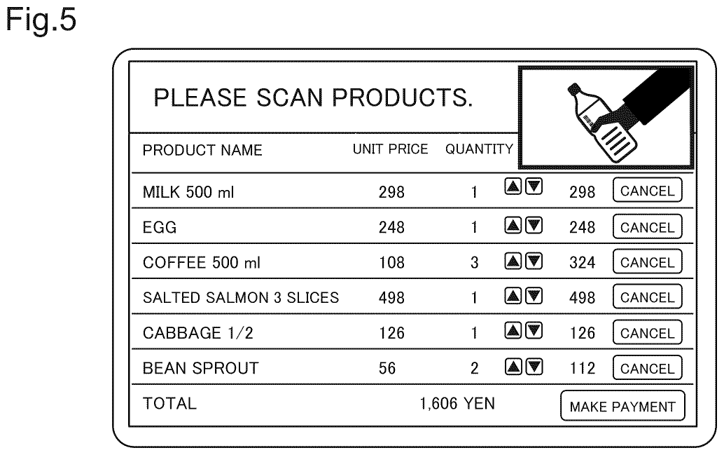

Here, FIG. 5 is a diagram illustrating an example of the display screen of the self-checkout terminal 92. FIG. 5 illustrates an example of the display screen of the self-checkout terminal 92 when the customer is determined to be possibly performing a fraudulent act. Referring to FIG. 5, a moving image obtained by capturing hand movements of the customer operating the self-checkout terminal 92 is displayed on a part of the display screen. In the example of FIG. 5, a moving image obtained by capturing hand movements of registering a product is displayed on the display screen of the self-checkout terminal 92. The position and the size of the display of the moving image are not limited thereto. It is sufficient if the customer operating the self-checkout terminal 92 may check the moving image displayed on the display screen.

The output unit 113 may output an instruction to display the moving image on the display screen of the self-checkout terminal 92 regardless of the determination result by the determination unit 112. For example, the output unit 113 may output an instruction to display moving images from the start to the end of the accounting by the customer.

The output by the output unit 113 described above may be output at different timing depending on the determination result. For example, an exemplary case where the output unit 113 performs an output to the salesclerk terminal 94 will be described. In the case of being determined to be unfamiliar with the operation of the self-checkout terminal 92, the output unit 113 performs any of the outputs described above when the determination is made by the determination unit 112. On the other hand, when the determination unit 112 determines that the customer may be performing a fraudulent act, the output unit 113 may perform an output at predetermined time without performing an output at the time when the determination is made by the determination unit 112. The predetermined time is, for example, time after a predetermined time has elapsed from the determination. In addition, the predetermined time is time at which the customer finishes the product registration.

Moreover, the outputs by the output unit 113 may be optionally combined. As an example of the combination, the output unit 113 outputs notification to the salesclerk terminal 94 carried by the security staff when the customer is determined to be possibly performing a fraudulent act. Moreover, the output unit 113 may output an instruction to print the customer identification information on the receipt.

As another example of the combination, when the customer is determined to be possibly performing a fraudulent act, the output unit 113 outputs an instruction to display the moving image obtained by capturing the hand movements of the customer operating the self-checkout terminal 92 on the display screen of the self-checkout terminal 92. The output unit 113 may further output notification to the store terminal 93. The outputs by the output unit 113 may be optionally combined depending on, for example, the situation of the store.

Moreover, when the output unit 113 performs a plurality of outputs, the output unit 113 may perform the plurality of outputs with a time difference. For example, when a predetermined operation is not performed within a predetermined time after the first output of the output unit 113, the output unit 113 may perform the next output. The case where the customer is determined to be possibly performing a fraudulent act will be described. At this time, it is assumed that the determination unit 112 determines that the customer may be performing a fraudulent act because there is a product on which no scanning operation is performed by the hand of the customer. Accordingly, the output unit 113 first outputs an instruction to display a moving image obtained by capturing hand movements of the customer operating the self-checkout terminal 92 on the display screen of the self-checkout terminal 92. Then, after the instruction is output, the determination unit 112 continues to make determination. When the customer does not perform a scanning operation on the product that has not been subjected to the scanning operation within a predetermined time, the output unit 113 outputs notification to the store terminal 93.

In addition, when the determination unit 112 determines that the customer may be performing a fraudulent act, the output unit 113 first outputs notification to the salesclerk terminal 94 carried by the security staff. Then, when the security staff fails to deal with the customer within a predetermined time after the output of the notification by the output unit 113, the output unit 113 outputs an instruction. This instruction is an instruction to print the information that may be used to identify a potential fraudulent act on the receipt. On the other hand, when the security staff succeeds in dealing with the customer within the predetermined time after the output of the notification by the output unit 113, the output unit 113 outputs no instruction. This instruction is also an instruction to print the information that may be used to identify a potential fraudulent act on the receipt.

Here, whether the security staff has succeeded in dealing with the customer may be confirmed by an input to the salesclerk terminal 94 or to the self-checkout terminal 92 made by the security staff. The security staff inputs that the response to the customer has been completed to the salesclerk terminal 94 or the self-checkout terminal 92. When the input is made by the security staff, the salesclerk terminal 94 or the self-checkout terminal 92 transmits completion notification to the customer monitoring assistance device 11. It is assumed that the completion notification has been transmitted within a predetermined time after the output of the notification to the salesclerk terminal 94. In that case, the output unit 113 is not required to output an instruction to print the information that may be used to identify a potential fraudulent act on the receipt. When the completion notification is not transmitted within the predetermined time after the output of the notification to the salesclerk terminal 94, the output unit 113 outputs an instruction. This instruction is also an instruction to print the information that may be used to identify a potential fraudulent act on the receipt.

The output in the case where the customer is determined to have a possibility of performing a fraudulent act has been described above.

Next, the output when the customer is determined to be unfamiliar with the operation of the self-checkout terminal 92 will be described.

When the customer is determined to be possibly performing a fraudulent act, the output unit 113 does not perform the output to be described below.

The output unit 113 may output an instruction to display an operation guide for the customer on the display screen of the self-checkout terminal 92. For example, the output unit 113 may output, to the self-checkout terminal 92, an instruction to display guidance of the next operation to be performed by the customer on the display screen of the self-checkout terminal 92. The output unit 113 may output an instruction to output the guidance of the next operation to be performed by voice. The voice of the operation guide is output from a speaker (not illustrated), for example. The speaker is connected to the customer monitoring assistance device 11 by a wired or wireless network. The speaker may be included in the self-checkout terminal 92. In that case, the output unit 113 outputs the instruction to the self-checkout terminal 92.

An example of the guidance of the next operation to be performed will be described. When the hand of the customer continues to stop in front of the self-checkout terminal 92, the customer may not know the operation of the self-checkout terminal 92. In view of the above, the output unit 113 outputs an instruction to display an operation guide on the display screen of the self-checkout terminal 92. At this time, for example, the output unit 113 outputs an instruction to highlight a button that needs to be touched on the display screen. In addition, the output unit 113 may output an instruction to display an arrow on the display screen. The output unit 113 may further output an instruction to display text such as “touch here”, for example. The output unit 113 may further output an instruction to output voice such as “please press the upper right button”, for example.

The outputs by the output unit 113 when the customer is determined to be unfamiliar with the operation of the self-checkout terminal 92 may be optionally combined. For example, the output unit 113 outputs the operation guide to the customer. The output unit 113 may further output notification to the salesclerk terminal 94. The output unit 113 outputs an instruction to turn on the light to the self-checkout terminal 92. The output unit 113 may further output notification to the store terminal 93.

Moreover, when the output unit 113 performs a plurality of outputs, the output unit 113 may perform the plurality of outputs with a time difference. That is, the output unit 113 may perform the next output when the determination unit 112 determines that the customer is unfamiliar with the operation of the self-checkout terminal 92 again after a predetermined time has elapsed from the first output by the output unit 113. For example, the output unit 113 outputs the operation guide to the customer. Then, the determination unit 112 continues to make determination. The output unit 113 may output notification to the salesclerk terminal 94 when the determination unit 112 determines that the customer is unfamiliar with the operation of the self-checkout terminal 92 again after the predetermined time has elapsed.

In addition, when a predetermined operation is not performed within a predetermined time after the first output of the output unit 113, the output unit 113 may perform the next output. For example, the output unit 113 outputs an instruction to turn on the light to the self-checkout terminal 92. Then, when the predetermined operation is not performed within the predetermined time, the output unit 113 may output the notification to the salesclerk terminal 94. Here, examples of the predetermined operation include transmission of the completion notification described above. In response to the input to the salesclerk terminal 94 or to the self-checkout terminal 92 made by the salesclerk, the salesclerk terminal 94 or the self-checkout terminal 92 transmits the completion notification regarding the response to the customer to the customer monitoring assistance device 11. When this completion notification is not issued, the output unit 113 may output notification to the salesclerk terminal 94.

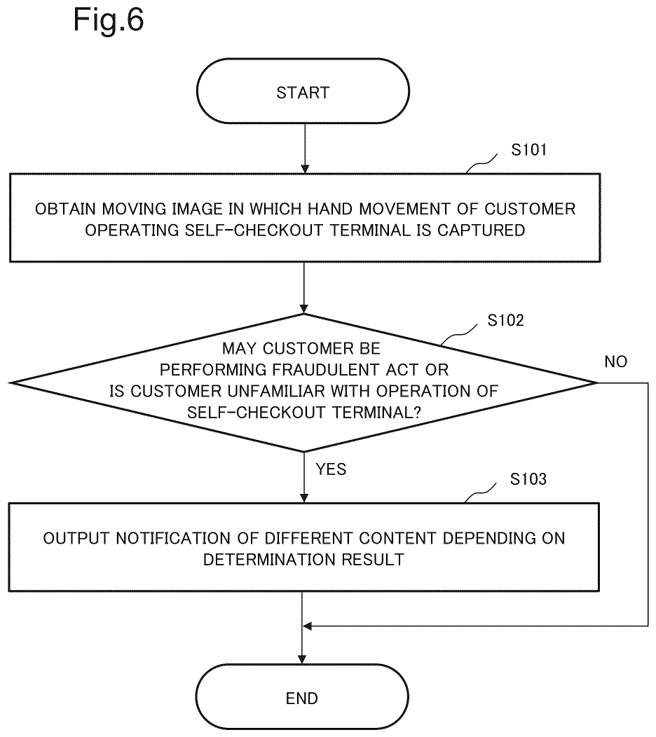

Next, the operation of the customer monitoring assistance device 11 will be described with reference to FIG. 6. FIG. 6 illustrates operation to be performed by the customer monitoring assistance device 11 in one accounting. That is, the customer monitoring assistance device 11 repeats the operation illustrated in FIG. 6 for each accounting.

First, in step S101, the acquisition unit 111 obtains a moving image obtained by capturing hand movements of the customer operating the self-checkout terminal 92.

Then, in step S102, the determination unit 112 determines whether the customer may be performing a fraudulent act or is unfamiliar with the operation of the self-checkout terminal 92. At this time, the determination made by the determination unit 112 is based on the hand movements of the customer. If the determination unit 112 determines that a fraudulent act may be performed or the customer is unfamiliar with the operation of the self-checkout terminal 92, the operation of the customer monitoring assistance device 11 proceeds to step S103 (YES in step S102). On the other hand, if the determination unit 112 determines that the customer has no possibility of performing a fraudulent act and is not unfamiliar with the operation of the self-checkout terminal 92 (NO in step S102), the customer monitoring assistance device 11 terminates the operation.

Then, in step S103, the output unit 113 outputs different contents depending on the determination result by the determination unit 112. Then, the customer monitoring assistance device 11 terminates the operation.

The customer monitoring assistance device 11 according to the present example embodiment determines, based on the hand movements of the customer, whether the customer may be performing a fraudulent act or is unfamiliar with the operation of the self-checkout terminal 92. Then, the customer monitoring assistance device 11 outputs different contents depending on the determination result. With the different contents being output depending on the determination result, an appropriate response according to the situation of the customer may be prompted. The person to whom the appropriate response is prompted is, for example, the salesclerk, the security staff, or the customer. With the different contents being output depending on the determination result, the person described above may be prompted to perform the appropriate response. Moreover, the customer monitoring assistance device 11 obtains a moving image obtained by capturing hand movements of the customer to make determination based on the hand movements of the customer. When the face of the customer is transferred to the moving image, a problem related to personal information may be raised. However, by obtaining the moving image obtained by capturing the hand movements and making determination based on the hand movements of the customer, it becomes possible to reduce the possibility of causing the problem related to the personal information.

In the customer monitoring assistance device 11 according to the present example embodiment, when the determination unit 112 determines that the customer may be performing a fraudulent act, the output unit 113 may output notification indicating that there is a customer who may be performing a fraudulent act. In that case, the salesclerk who carries the salesclerk terminal 94 to which the notification has been output checks the notification. Then, the salesclerk may grasp that there is a customer who may be performing a fraudulent act. By grasping that there is a customer who may be performing a fraudulent act, the salesclerk may take measures against the fraudulent act or call for attention. Thus, an appropriate response depending on the situation of the customer may be prompted.

In the customer monitoring assistance device 11 according to the present example embodiment, the output unit 113 may perform an output to the terminal carried by the security staff when the customer is determined to be possibly performing a fraudulent act. In that case, the security staff who carries the terminal to which the notification has been output checks the notification. Then, the security staff may deal with the customer who may be performing a fraudulent act. As described above, the output of the notification indicating that there is a customer who may be performing a fraudulent act may prompt an appropriate response depending on the situation of the customer.

In the customer monitoring assistance device 11 according to the present example embodiment, when the determination unit 112 determines that the customer is unfamiliar with the operation, the output unit 113 may output an instruction to support the customer determined to be unfamiliar with the operation. In that case, when the output unit 113 outputs the instruction to the store terminal 93, the salesclerk who has checked the store terminal 93 may voluntarily go to the operational support. Moreover, measures may be considered regarding familiarization of customers with the operational method. Thus, an appropriate response depending on the situation of the customer may be prompted.

In the customer monitoring assistance device 11 according to the present example embodiment, when the determination unit 112 determines that the customer is unfamiliar with the operation, the output unit 113 may perform an output to the terminal carried by the salesclerk. In that case, the salesclerk who carries the salesclerk terminal 94 to which the instruction has been output may go to the operational support for the customer determined to be unfamiliar with the operation. Thus, an appropriate response depending on the situation of the customer may be prompted. The customer may also understand the operation and perform accounting, thereby improving customer convenience.

In the customer monitoring assistance device 11 according to the present example embodiment, the output unit 113 may perform an output to a different output destination depending on whether the determination unit 112 determines that the customer may be possibly performing a fraudulent act or determines that the customer is unfamiliar with the operation. In that case, examples of the output destination include the salesclerk terminal 94, the store terminal 93, and the light provided at the checkout terminal. For example, in the case of being determined to be unfamiliar with the operation, the output unit 113 outputs an instruction to turn on the light. On the other hand, in the case of being determined to have a possibility of performing a fraudulent act, the output unit 113 does not output the instruction to turn on the light. However, the output unit 113 outputs notification to the salesclerk terminal 94 or to the store terminal 93. In this manner, the output unit 113 may perform the output to different notification destinations.

If the output unit 113 outputs the instruction to turn on the light also in the case where the customer is determined to be possibly performing a fraudulent act, the customer may recognize the determination result. As a result, the customer may destroy evidence or escape. Meanwhile, if the output unit 113 outputs the notification to the salesclerk terminal 94 or to the store terminal 93, the customer does not recognize the determination result. The output unit 113 issues the instruction to turn on the light in the case of being determined to be unfamiliar with the operation, whereby the salesclerk is enabled to take an appropriate action. For example, when the instruction is output to the salesclerk terminal 94, the salesclerk needs to check the screen of the salesclerk terminal 94. However, with the light provided at the self-checkout terminal 92 being turned on, the salesclerk may easily confirm that there is a customer who is unfamiliar with the operation and the position of the self-checkout terminal 92 used by the customer. Then, the operational support for the customer may be started earlier than in the case where the notification is output to the salesclerk terminal 94. Thus, an appropriate response depending on the situation of the customer may be prompted.

In the customer monitoring assistance device 11 according to the present example embodiment, when the customer is determined to be possibly performing a fraudulent act, the output unit 113 may output an instruction to print, on the receipt, the information that may be used to identify a potential fraudulent act of the customer. In that case, the salesclerk may grasp that the customer is determined to have a possibility of performing a fraudulent act using the information that may be used to identify a potential fraudulent act of the customer. Thus, an appropriate response depending on the situation of the customer may be prompted.

In the customer monitoring assistance device 11 according to the present example embodiment, the output unit 113 may output the moving image, which is captured within a predetermined time before and after the time at which the customer may have a possibility of performing a fraudulent act and is stored in association with the information that may be used to identify a potential fraudulent act. In that case, when the moving image before and after the time at which a fraudulent act may be performed is output, the salesclerk or the customer may check the moving image. As a result, whether the customer has actually performed the fraudulent act may be confirmed.

The case where the customer is determined to have a possibility of performing a fraudulent act includes, for example, a case caused by a misunderstanding or an operational error of the customer. In view of the above, the salesclerk needs to distinguish whether the fraudulent act has been intentionally performed or the fraudulent act has been determined due to a misunderstanding or an operational error of the customer. By checking the moving image, the salesclerk may distinguish between the intentional fraudulent act and the misunderstanding or operational error of the customer. When the salesclerk succeeds in distinguishing between the intentional fraudulent act and the misunderstanding or operational error of the customer, the salesclerk may take a different action depending on the situation. Thus, an appropriate response depending on the situation of the customer may be prompted.

In the customer monitoring assistance device 11 according to the present example embodiment, when the determination unit 112 determines that the customer may be performing a fraudulent act, the output unit 113 may output an instruction to display a moving image obtained by capturing hand movements of the customer on the display screen of the self-checkout terminal 92. In that case, the customer then checks the moving image displayed on the display screen. As a result, the customer recognizes that the hand movements of him/herself are being captured. As a result, the customer may give up performing a fraudulent act. That is, the display of the moving image obtained by capturing the hand movements of the customer on the display screen of the self-checkout terminal 92 may suppress a fraudulent act of the customer. Thus, an appropriate response may be prompted to the customer.

In the customer monitoring assistance device 11 according to the present example embodiment, when the hand of the customer performs the same operation on the self-checkout terminal 92 for equal to or more than a predetermined time, the determination unit 112 may determine that the customer is unfamiliar with the operation of the self-checkout terminal 92. In that case, performing the same operation for equal to or more than the predetermined time indicates, for example, a case where the hand of the customer is stationary for equal to or more than the predetermined time with respect to the self-checkout terminal 92. In that case, the operation may be stopped because the customer does not know the operation to be performed on the self-checkout terminal 92. In addition, performing the same operation for equal to or more than the predetermined time indicates a case where the hand of the customer performs an operation of searching for the product identification information attached to the product for equal to or more than the predetermined time. At this time, the customer may be in trouble without finding the position of the product identification information. In view of the above, support by the salesclerk is needed. In addition, for example, the product identification information may not be attached due to a mistake of the salesclerk. In such a case, it can be said that the support by the salesclerk is needed. Thus, the determination unit 112 may appropriately determine the situation of the customer. As a result, an appropriate response depending on the situation of the customer may be prompted.

### Second Example Embodiment

Next, a second example embodiment of the present disclosure will be described. Hereinafter, descriptions of contents overlapping with the descriptions above will be omitted to the extent that descriptions of the present example embodiment are not unclear.

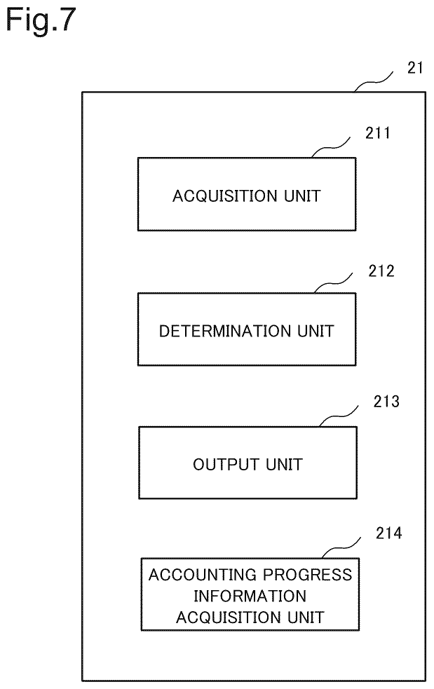

FIG. 7 is a block diagram illustrating a configuration of a customer monitoring assistance device 21 according to the present disclosure.

Referring to FIG. 7, the customer monitoring assistance device 21 further includes an accounting progress information acquisition unit 214 as compared with the customer monitoring assistance device 11 according to the first example embodiment. In addition, a determination unit 212 determines whether a customer may be performing a fraudulent act or is unfamiliar with an operation of a self-checkout terminal 92 using, in addition to hand movements of the customer, accounting progress information. Then, an output unit 213 performs the output described above.

The accounting progress information acquisition unit 214 is an aspect of an accounting progress information acquisition means that obtains the accounting progress information, which is information by which a progress state of accounting may be grasped. The accounting progress information includes at least one of registered product information, same screen display duration information, or accounting process information.

First, each of the registered product information, the same screen display duration information, and the accounting process information included in the accounting progress information will be described.

The registered product information is a list of pieces of information regarding products that have been registered among products to be purchased by the customer. The registered product information includes product identification information and the number of each product registered by the customer. The product identification information is, for example, a name of a product or a number assigned to the product. The registered product information may further include information regarding time at which the product is registered by the customer. Then, the registered product information is stored in a memory of the self-checkout terminal 92 or in an external memory connected to the self-checkout terminal 92. When the customer registers a product, the product identification information and the number of the registered product are added to the registered product information. When a plurality of the same products is purchased, the number of registered products is overwritten in the registered product information.

The accounting progress information acquisition unit 214 obtains the registered product information stored in the memory of the self-checkout terminal 92 or in the external memory connected to the self-checkout terminal 92. Then, the determination unit 212 uses the registered product information to determine whether the customer may be performing a fraudulent act or is unfamiliar with the operation of the self-checkout terminal 92.

Next, the same screen display duration information is information regarding a time during which the same screen is displayed at the self-checkout terminal 92, that is, a display duration of the same screen. Each time the contents displayed on the screen of the self-checkout terminal 92 transition, the self-checkout terminal 92 measures the time during which the screen is displayed. The determination unit 212 may periodically obtain the same screen display duration information from the self-checkout terminal 92. In addition, when the same screen display duration exceeds a predetermined time, the self-checkout terminal 92 transmits the same screen display duration information to the customer monitoring assistance device 21. Then, the accounting progress information acquisition unit 214 may obtain the same screen display duration information. Then, the determination unit 212 determines whether the customer may be performing a fraudulent act or is unfamiliar with the operation of the self-checkout terminal 92 based on the same screen display duration information obtained from the self-checkout terminal 92.

Then, the accounting process information includes information regarding a process displayed on the display screen of the self-checkout terminal 92 for the accounting of the customer. The process is a series of operations for the customer to perform accounting at the self-checkout terminal. Specifically, examples thereof include a product registration process, which is a process through which the customer registers a product, and a payment process through which the customer makes a payment. In addition, membership information registration process, which is a process for performing an operation to associate accounting contents with customer membership information registered in advance, may be further included. For example, the customer reads a point card as the registration of the membership information. A payment method selection process through which the customer selects a payment method may be further included before the payment is made. The accounting process information is not limited to the above. The process includes a process relevant to each operation that needs to be performed by the customer to perform the accounting.

Each time the process transitions, the self-checkout terminal 92 may transmit the accounting process information to the customer monitoring assistance device 21. The accounting progress information acquisition unit 214 obtains the accounting process information. In addition, the accounting progress information acquisition unit 214 may periodically obtain the accounting process information from the self-checkout terminal 92.

Next, the determination to be made by the determination unit 112 using the hand movements of the customer and the accounting progress information will be described. First, determination on whether the customer may be performing a fraudulent act, which is made using the registered product information, will be described.

For example, the accounting progress information acquisition unit 214 obtains the registered product information each time the hand of the customer performs a scanning operation. Then, the determination unit 212 checks whether the product on which the hand of the customer has performed the scanning operation is included in the registered product information. Then, when the product on which the hand of the customer has performed the scanning operation is not included in the registered product information, the determination unit 112 determines that the customer may be performing a fraudulent act. On the other hand, when the product on which the hand of the customer has performed the scanning operation is included in the registered product information, it is determined that the customer has no possibility of performing a fraudulent act.

The accounting progress information acquisition unit 214 obtains the registered product information each time the hand of the customer performs the scanning operation. Then, the determination unit 212 may check whether the product registered at the time when the scanning operation is performed by the hand of the customer is included in the registered product information. When the product registered at the time when the scanning operation is performed by the hand of the customer is not included in the registered product information, the determination unit 212 determines that the customer may be performing a fraudulent act. On the other hand, when the product registered at the time when the scanning operation is performed by the hand of the customer is included in the registered product information, the determination unit 212 determines that the customer has no possibility of performing a fraudulent act.

As another example of the determination made by the determination unit 212 using the registered product information, the accounting progress information acquisition unit 214 may obtain the registered product information when the registration of all the products is complete. First, the accounting progress information acquisition unit 214 detects the completion of the product registration by, for example, the operation of the self-checkout terminal 92 by the customer. Examples of the operation of the self-checkout terminal 92 by the customer include pressing of a subtotal button by the customer. It may be any operation as long as transition to the next screen or process is caused by the operation.

Then, when the customer presses the subtotal button of the self-checkout terminal 92, the accounting progress information acquisition unit 214 detects the completion of the product registration. Moreover, the accounting progress information acquisition unit 214 obtains the registered product information. The determination unit 212 checks whether the product on which the hand of the customer has performed the scanning operation is included in the registered product information. Then, the determination unit 212 checks whether all the products on which the hand of the customer has performed the scanning operation are included in the registered product information. Then, when the product on which the hand of the customer has performed the scanning operation is not included in the registered product information, the determination unit 212 determines that the customer may be performing a fraudulent act. On the other hand, when the product on which the hand of the customer has performed the scanning operation is included in the registered product information, it is determined that the customer has no possibility of performing a fraudulent act.

The determination unit 212 may check whether the product registered at the time when the scanning operation is performed by the hand of the customer is included in the registered product information. When the product registered at the time when the scanning operation is performed by the hand of the customer is not included in the registered product information, the determination unit 212 determines that the customer may be performing a fraudulent act. On the other hand, when the product registered at the time when the scanning operation is performed by the hand of the customer is included in the registered product information, the determination unit 212 determines that the customer has no possibility of performing a fraudulent act.

The accounting progress information acquisition unit 214 may detect the completion of the product registration based on a state of a table on which the products before registration are placed by the customer. For example, a camera 91 may be installed at a position where the table on which the products before product registration are placed by the customer may be captured. The camera 91 is connected to the self-checkout terminal 92 or to the customer monitoring assistance device 21. Then, the customer monitoring assistance device 21 obtains a moving image obtained by capturing the table on which the products before product registration are placed by the customer. Then, the accounting progress information acquisition unit 214 may detect the completion of the registration of all the products when the products placed on the table disappear. The operation of the customer monitoring assistance device 21 after the completion of the product registration is detected by the accounting progress information acquisition unit 214 is as described above.

Here, when the product on which the hand of the customer has performed the scanning operation is not included in the registered product information, the determination unit 212 may determine whether the customer may be performing a fraudulent act again based on the hand movements of the customer and the registered product information. When the product on which the hand of the customer has performed the scanning operation is not included in the registered product information, for example, there may be a case where the product on which the hand of the customer has performed the scanning operation is not included in the registered product information even though the customer has no fraudulent intention. Specifically, examples of a conceivable cause include a misunderstanding or an operational error of the customer, and a malfunction of the self-checkout terminal 92. In such a case, the customer may perform re-scanning. In view of the above, when the product on which the hand of the customer has performed the scanning operation is not included in the registered product information, the determination unit 212 determines whether the customer may be performing a fraudulent act again based on the hand movements of the customer and the registered product information.

For example, the accounting progress information acquisition unit 214 obtains the registered product information each time the hand of the customer performs a scanning operation. Then, when there is a product not included in the registered product information even though the hand of the customer has performed the scanning operation and the scanning operation by the customer is not performed again by the end of the accounting, the determination unit 212 may determine that the customer may be performing a fraudulent act. On the other hand, even in the case where there is a product not included in the registered product information even though the hand of the customer has performed the scanning operation, if the scanning operation by the customer is performed again by the end of the accounting, the determination unit 212 may determine that the customer has no possibility of performing a fraudulent act.

In addition, when the completion of the product registration is detected, the accounting progress information acquisition unit 214 may obtain the registered product information again. Then, when the registered product information at the end of the product registration includes the product, which has not been included in the registered product information even though the hand of the customer has performed the scanning operation, the determination unit 212 determines that the customer has no possibility of performing a fraudulent act. That is, the product is included in the registered product information due to the re-scanning by the customer. On the other hand, when the registered product information at the end of the product registration does not include the product, which has not been included in the registered product information even though the hand of the customer has performed the scanning operation, the determination unit 212 determines that the customer may be performing a fraudulent act.

The determination as to whether the customer may be performing a fraudulent act, which is made by the determination unit 212 using the registered product information, has been described above.

Next, the determination as to whether the customer is unfamiliar with the operation of the self-checkout terminal 92, which is made by the determination unit 212 using the same screen display duration information, will be described. The accounting progress information acquisition unit 214 obtains the same screen display duration information from the self-checkout terminal 92. Then, when the same screen display duration information is equal to or more than a predetermined time, the determination unit 212 may determine that the customer is unfamiliar with the operation of the self-checkout terminal 92.

However, even when the same screen is continuously displayed for equal to or more than the predetermined time, the customer may not be unfamiliar with the operation. In view of the above, the determination unit 212 may determine as to whether the customer is unfamiliar with the operation using other conditions. For example, when the same screen display duration information is equal to or more than the predetermined time and the hand of the customer performs the same operation for equal to or more than the predetermined time, the determination unit 212 may determine that the customer is unfamiliar with the operation of the self-checkout terminal 92. Examples of the case where the customer is not unfamiliar with the operation even when the same screen is continuously displayed for equal to or more than the predetermined time include a case where the customer is taking care of a child even though the customer knows the operation. The customer may have a trouble in taking out the wallet from the bag. That is, even a customer who understands the operation may not progress the operation due to actions other than the accounting. In view of the above, the determination unit 212 may determine that the customer is unfamiliar with the operation of the self-checkout terminal 92 based on the hand movements of the customer together with the same screen display duration information.

Next, the determination as to whether the customer is unfamiliar with the operation of the self-checkout terminal 92, which is made by the determination unit 212 using the accounting process information, will be described. The accounting progress information acquisition unit 214 obtains the accounting process information from the self-checkout terminal 92. Then, information regarding an operation required for each process to be performed by the customer on the self-checkout terminal 92 is stored in association with the process. The information regarding an operation required for each process is stored in advance in a memory of the customer monitoring assistance device 21 or in an external memory connected to the customer monitoring assistance device 21.

The determination unit 212 reads information regarding an operation required for the process indicated by the accounting process information. The required operation here is an operation of the hand of the customer. Examples of an operation required for the product registration process include an operation of picking up a product, and an operation of performing scanning. Examples of an operation required for the payment process include an operation of putting cash into the self-checkout terminal 92, an operation of inserting a credit card into the self-checkout terminal 92, and an operation of causing the self-checkout terminal 92 to read a bar code displayed on a mobile terminal of the customer to make a bar code payment. Moreover, examples of an operation required for the membership information registration process include an operation of causing a point card to be read. Examples of an operation required for the payment method selection process include an operation of pressing the display screen of the self-checkout terminal 92.

Then, the determination unit 212 checks whether the hand of the customer performs an operation different from the operation required for the process indicated by the accounting process information. A case where the hand of the customer performs an operation different from the operation required for the process will be described. For example, it is conceivable that the customer tries to cause the self-checkout terminal 92 to read a point card while the process displayed on the display screen of the self-checkout terminal 92 is the product registration process. In addition, it is conceivable that the customer tries to put cash into the self-checkout terminal 92 while the process displayed on the display screen of the self-checkout terminal 92 is the payment method selection process. An example of the case where the hand of the customer performs an operation different from the operation required for the process indicated by the accounting process information is not limited to the above.

When the hand of the customer does not perform an operation different from the required operation, the determination unit 212 determines that the customer is not unfamiliar with the operation of the self-checkout terminal 92. On the other hand, when an operation different from the required operation is performed, the determination unit 212 determines that the customer is unfamiliar with the operation of the self-checkout terminal 92.

Moreover, the determination unit 212 may determine that the customer is unfamiliar with the operation of the self-checkout terminal 92 when the hand of the customer performs an operation different from the operation required for the process indicated by the accounting process information for equal to or more than a predetermined time. Even when the hand of the customer performs an operation different from the operation required for the process indicated by the accounting process information, the customer him/herself may notice the mistake. In that case, the customer stops the operation different from the operation required for the process. Then, the customer may perform the operation required for the process. When the customer performs the operation required for the process, the determination unit 212 determines that the customer is not unfamiliar with the operation. As a result, the output unit 213 does not need to perform an output.

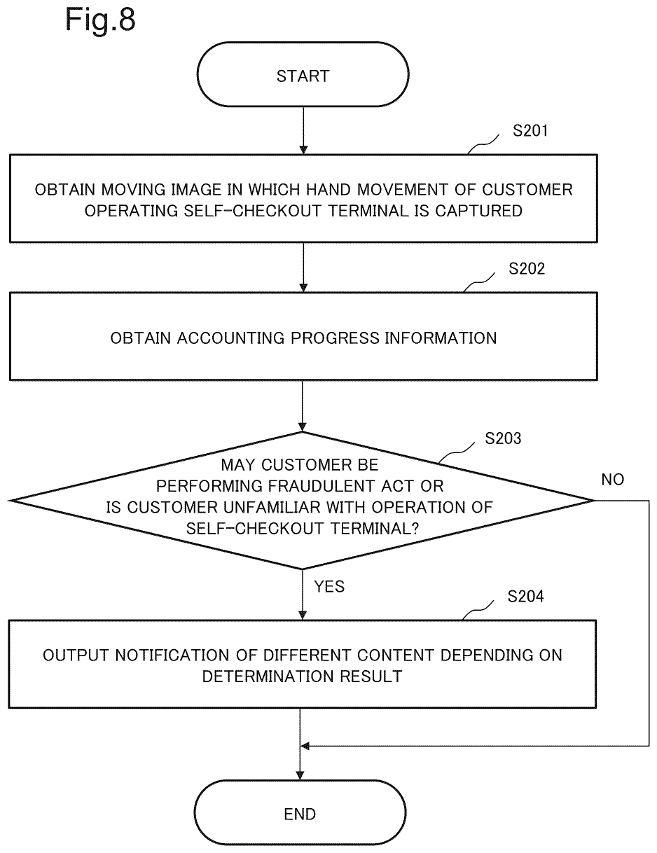

Next, the operation of the customer monitoring assistance device 21 will be described with reference to FIG. 8.

As compared with the first example embodiment illustrated in FIG. 6, step S101 and step S201 execute the same operation.

Then, in step S202, the accounting progress information acquisition unit 214 obtains the accounting progress information. Then, in step S203, the determination unit 212 determines whether the customer may be performing a fraudulent act or is unfamiliar with the operation of the self-checkout terminal 92. At this time, the determination by the determination unit 212 is based on the hand movements of the customer and the accounting progress information.

Then, if the determination unit 212 determines that the customer may be performing a fraudulent act or is unfamiliar with the operation of the self-checkout terminal 92, the operation of the customer monitoring assistance device 21 proceeds to step S103 (YES in step S203). On the other hand, if the determination unit 212 determines that the customer has no possibility of performing a fraudulent act and is not unfamiliar with the operation of the self-checkout terminal 92, the customer monitoring assistance device 21 terminates the operation (NO in step S203).

In step S204, the output unit 213 outputs different contents depending on the determination result by the determination unit 212. Then, the customer monitoring assistance device 21 terminates the operation.

In the customer monitoring assistance device 21 according to the present example embodiment determines, the determination unit 212 determines whether the customer may be performing a fraudulent act or is unfamiliar with the operation of the self-checkout terminal 92 using the hand movements of the customer and the accounting progress information. The accounting progress information is information by which a progress state of accounting may be grasped. The determination unit 212 makes determination using the hand movements of the customer and the accounting progress information. At the time of making determination using the hand movements, it may be difficult to make accurate determination. However, with the accounting progress information being used, accuracy in the determination may improve. As a result, an appropriate response depending on the situation of the customer may be prompted.

In the customer monitoring assistance device 21 according to the present example embodiment, the determination unit 212 may determine that the customer may be performing a fraudulent act when the information regarding the product on which the hand of the customer has performed the scanning operation is not registered in the product registration information. In that case, the determination unit 212 may improve the accuracy in the determination by using the hand movements of the customer and the product registration information. For example, a fraudulent act is conceivable in which the customer does not actually register the product although the hand of the customer performs the scanning operation. The determination unit 212 may determine that the customer may be performing a fraudulent act even in the case of such a fraudulent act. As a result, the accuracy in the determination by the determination unit 212 may improve.

In the customer monitoring assistance device 21 according to the present example embodiment, the accounting progress information acquisition unit 214 may obtain the accounting process information including the information regarding the process displayed on the self-checkout terminal 92, and the determination unit 212 may determine that the customer is unfamiliar with the operation of the self-checkout terminal 92 when the hand of the customer performs, on the self-checkout terminal 92, an operation different from the operation required for the process for equal to or more than a predetermined time. In that case, when the customer does not understand the operation of the self-checkout terminal 92, an operation different from the operation required for the process may be performed for equal to or more than a predetermined time. The customer who understands the operation of the self-checkout terminal 92 may perform the same operation as a normal operation in a situation in which an operation different from the normal operation is required. In such situations, operational support may be required. In view of the above, the determination unit 212 determines that the customer is unfamiliar with the operation of the self-checkout terminal 92 when the hand of the customer performs, on the self-checkout terminal 92, an operation different from the operation required for the process for equal to or more than the predetermined time. As a result, the accuracy in the determination by the determination unit 212 may improve. An appropriate response depending on the situation of the customer may be prompted.

### Exemplary Hardware Configuration

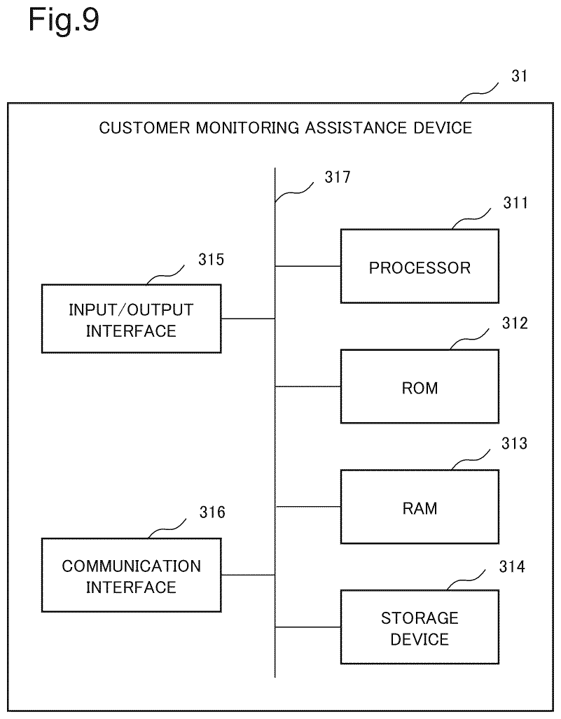

FIG. 9 is a diagram illustrating an exemplary hardware configuration of a customer monitoring assistance device 31 according to the present disclosure. The customer monitoring assistance device 31 is implemented by a computer.

The customer monitoring assistance device 31 includes a processor 311, a read only memory (ROM) 312, a random access memory (RAM) 313, a storage device 314 such as a hard disk for storing programs, an input/output interface 315 for inputting/outputting data, and a communication interface 316 for network connection. The components are connected via a bus 317.

The processor 311 operates an operating system to take overall control of the computer. Examples of the processor 311 include a central processing unit (CPU), a digital signal processor (DSP), and a graphics processing unit (GPU). The processor loads a program stored in, for example, the ROM 312, the storage device 314, or the like. Then, the processor 311 executes each process coded in the program. The processor 311 may execute processing or instructions in the illustrated flowchart based on the program.

The ROM 312 stores an application program, a program according to each example embodiment, and the like. The RAM 313 is used as a work area of the processor 311.

Examples of the storage device 314 include a semiconductor memory such as a flash memory, a hard disk driver (HDD), and the like. The storage device 314 stores, for example, an operating system (OS) program, an application program, a program according to each example embodiment, and the like.

The input/output interface 315 is connected to a peripheral device (not illustrated). A method of the connection may be wired or wireless. Examples of the peripheral device include a display as an output device.

The communication interface 316 is connected to a communication network (not illustrated) such as a local network (LAN) or a wide area network (WAN) through a wireless or wired communication line. The communication network may include a plurality of communication networks. As a result, the computer is connected to an external device via the communication network.

Some or all of the example embodiments described above may also be described as the following Supplementary Notes. However, some or all of the example embodiments described above are not limited to the following.

### Supplementary Note 1

A customer monitoring assistance device including:
an acquisition means for obtaining a moving image obtained by capturing a movement of a hand of a customer who operates a self-checkout terminal;
a determination means for determining whether the customer has a possibility of performing a fraudulent act or is unfamiliar with an operation of the self-checkout terminal based on the movement of the hand of the customer; and
an output means for outputting different content depending on a determination result.

### Supplementary Note 2

The customer monitoring assistance device according to Supplementary Note 1, in which
the output means outputs notification indicating that there is the customer who has the possibility of performing the fraudulent act when the determination means determines that the customer has the possibility of performing the fraudulent act.

### Supplementary Note 3

The customer monitoring assistance device according to Supplementary Note 1 or 2, in which
the output means outputs an instruction to support the customer determined to be unfamiliar with the operation when the determination means determines that the customer is unfamiliar with the operation.

Supplementary Note 4

The customer monitoring assistance device according to any one of Supplementary Notes 1 to 3, in which
the output means performs the output to a different output destination depending on whether the determination means determines that the customer has the possibility of performing the fraudulent act or is unfamiliar with the operation.

### Supplementary Note 5

The customer monitoring assistance device according to any one of Supplementary Notes 1 to 4, in which
the output means performs the output to a terminal carried by a security staff when the determination means determines that the customer has the possibility of performing the fraudulent act.

### Supplementary Note 6

The customer monitoring assistance device according to any one of Supplementary Notes 1 to 5, in which
the output means performs the output to a terminal carried by a salesclerk when the determination means determines that the customer is unfamiliar with the operation.

### Supplementary Note 7

The customer monitoring assistance device according to any one of Supplementary Notes 1 to 6, in which
the output means outputs, on a receipt, information that may be used to identify the possibility of performing the fraudulent act of the customer when the determination means determines that the customer has the possibility of performing the fraudulent act.

### Supplementary Note 8

The customer monitoring assistance device according to Supplementary Note 7, in which
the output means outputs the moving image captured within a predetermined time before and after time at which the customer has the possibility of performing the fraudulent act, the moving image being stored in association with the information that may be used to identify the possibility of performing the fraudulent act.

### (Supplementary Note 9

The customer monitoring assistance device according to any one of Supplementary Notes 1 to 8, in which
the output means outputs the moving image obtained by capturing the movement of the hand of the customer on a screen of the self-checkout terminal when the determination means determines that the customer has the possibility of performing the fraudulent act.

### Supplementary Note 10

The customer monitoring assistance device according to any one of Supplementary Notes 1 to 9, in which
the determination means determines that the customer has the possibility of performing the fraudulent act when there is a product on which no scanning operation is performed by the hand of the customer.

### Supplementary Note 11

The customer monitoring assistance device according to any one of Supplementary Notes 1 to 10, in which
the determination means determines that the customer is unfamiliar with the operation of the self-checkout terminal when the hand of the customer performs a same operation on the self-checkout terminal for equal to or more than a predetermined time.

### Supplementary Note 12

The customer monitoring assistance device according to any one of Supplementary Notes 1 to 11, in which
the determination means determines that the customer is unfamiliar with the operation of the self-checkout terminal when the hand of the customer is stationary for equal to or more than a predetermined time with respect to the self-checkout terminal.

### Supplementary Note 13

The customer monitoring assistance device according to any one of Supplementary Notes 1 to 12, in which
the determination means determines that the customer is unfamiliar with the operation of the self-checkout terminal when the hand of the customer performs an operation of searching for product identification information attached to a product for equal to or more than a predetermined time.

### Supplementary Note 14

The customer monitoring assistance device according to any one of Supplementary Notes 1 to 13, further including:
an accounting progress information acquisition means for obtaining accounting progress information that is information by which a progress state of accounting may be grasped, in which
the determination means determines whether the customer has the possibility of performing the fraudulent act or is unfamiliar with the operation of the self-checkout terminal using the movement of the hand of the customer and the accounting progress information.

### Supplementary Note 15

The customer monitoring assistance device according to Supplementary Note 14, in which
the accounting progress information includes at least one of registered product information, same screen display duration information, or accounting process information.

### Supplementary Note 16

The customer monitoring assistance device according to Supplementary Note 15, in which
the accounting progress information acquisition means obtains the registered product information, and
the determination means determines that the customer has the possibility of performing the fraudulent act when information regarding a product on which a scanning operation is performed by the hand of the customer is not registered in the registered product information.

### Supplementary Note 17

The customer monitoring assistance device according to Supplementary Note 15 or 16, in which
the accounting progress information acquisition means obtains the display duration information, and
the determination means determines that the customer is unfamiliar with the operation of the self-checkout terminal when the display duration information is equal to or more than a predetermined time and the hand of the customer repeatedly performs a same operation on the self-checkout terminal.

### Supplementary Note 18

The customer monitoring assistance device according to any one of Supplementary Notes 15 to 17, in which
the accounting progress information acquisition means obtains the accounting process information including information regarding a process displayed on the self-checkout terminal, and
the determination means determines that the customer is unfamiliar with the operation of the self-checkout terminal when the hand of the customer performs, on the self-checkout terminal, an operation different from an operation required for the process for equal to or more than a predetermined time.

### Supplementary Note 19

A customer monitoring assistance method including:
obtaining a moving image obtained by capturing a movement of a hand of a customer who operates a self-checkout terminal;
determining whether the customer has a possibility of performing a fraudulent act or is unfamiliar with an operation of the self-checkout terminal based on the movement of the hand of the customer; and
outputting different content depending on a determination result.

### Supplementary Note 20

A recording medium storing a customer monitoring assistance device program for causing a computer to perform a process including:
a step of obtaining a moving image obtained by capturing a movement of a hand of a customer who operates a self-checkout terminal;
a step of determining whether the customer has a possibility of performing a fraudulent act or is unfamiliar with an operation of the self-checkout terminal based on the movement of the hand of the customer; and
a step of outputting different content depending on a determination result.

### REFERENCE SIGNS LIST

1 customer monitoring assistance system
11, 21, 31 customer monitoring assistance device
111, 211 acquisition unit
112, 212 determination unit
113, 213 output unit
214 accounting progress information acquisition unit
311 processor
312 ROM
313 RAM
314 storage device
315 input/output interface
316 communication interface
317 bus
91 camera
92 self-checkout terminal
93 store terminal
94 salesclerk terminal

What is claimed is:

1. A customer monitoring assistance device comprising:
one or more memories storing instructions; and
one or more processors configured to execute the instructions to:
obtain a moving image obtained by capturing a movement of a hand of a customer who operates a self-checkout terminal;
determine whether the customer has a possibility of performing a fraudulent act or is unfamiliar with an operation of the self-checkout terminal based on the movement of the hand of the customer; and
output different content depending on a determination result.

2. The customer monitoring assistance device according to claim 1, wherein
the one or more processors are configured to execute the instructions to the output a notification indicating that there is the customer who has the possibility of performing the fraudulent act when the one or more processors determine that the customer has the possibility of performing the fraudulent act.

3. The customer monitoring assistance device according to claim 1, wherein
the one or more processors are configured to execute the instructions to the output an instruction to support the customer determined to be unfamiliar with the operation when the one or more processors determine that the customer is unfamiliar with the operation.

4. The customer monitoring assistance device according to claim 1, wherein
the one or more processors are configured to execute the instructions to output to a different output destination depending on whether the one or more processors determine that the customer has the possibility of performing the fraudulent act or is unfamiliar with the operation.

5. The customer monitoring assistance device according to claim 4, wherein
the one or more processors are configured to execute the instructions to the output to a terminal carried by a security staff when the one or more processors determine that the customer has the possibility of performing the fraudulent act.

6. The customer monitoring assistance device according to claim 4, wherein
the one or more processors are configured to execute the instructions to output to a terminal carried by a salesclerk when the one or more processors determine that the customer is unfamiliar with the operation.

7. The customer monitoring assistance device according to claim 1, wherein
the one or more processors are configured to execute the instructions to output an instruction to print, on a receipt, information that may be used to identify the possibility of performing the fraudulent act of the customer when the one or more processors determine that the customer has the possibility of performing the fraudulent act.

8. The customer monitoring assistance device according to claim 7, wherein
the one or more processors are configured to execute the instructions to output an instruction to display the moving image captured within a predetermined time before and after time at which the customer has the possibility of performing the fraudulent act, the moving image being stored in association with the information that may be used to identify the possibility of performing the fraudulent act.

9. The customer monitoring assistance device according to claim 1, wherein
the one or more processors are configured to execute the instructions to output an instruction to display the moving image obtained by capturing the movement of the hand of the customer on a screen of the self-checkout terminal when the one or more processors determine that the customer has the possibility of performing the fraudulent act.

10. The customer monitoring assistance device according to claim 1, wherein
the one or more processors are configured to execute the instructions to determine that the customer has the possibility of performing the fraudulent act when there is a product on which no scanning operation is performed by the hand of the customer.

11. The customer monitoring assistance device according to claim 1, wherein
the one or more processors are configured to execute the instructions to determine that the customer is unfamiliar with the operation of the self-checkout terminal when the hand of the customer performs a same operation on the self-checkout terminal for equal to or more than a predetermined time.

12. The customer monitoring assistance device according to claim 1, wherein
the one or more processors are configured to execute the instructions to determine that the customer is unfamiliar with the operation of the self-checkout terminal when the hand of the customer is stationary for equal to or more than a predetermined time with respect to the self-checkout terminal.

13. The customer monitoring assistance device according to claim 11, wherein
the one or more processors are configured to execute the instructions to determine that the customer is unfamiliar with the operation of the self-checkout terminal when the hand of the customer performs an operation of searching for product identification information attached to a product for equal to or more than a predetermined time.

14. The customer monitoring assistance device according to claim 1,
wherein the one or more processors are further configured to execute the instructions to:
obtain accounting progress information that is information by which a progress state of accounting may be grasped; and
the determine whether the customer has the possibility of performing the fraudulent act or is unfamiliar with the operation of the self-checkout terminal using the movement of the hand of the customer and the accounting progress information.

15. The customer monitoring assistance device according to claim 14, wherein
the accounting progress information includes at least one of registered product information, same screen display duration information, or accounting process information.

16. The customer monitoring assistance device according to claim 15, wherein
the one or more processors are further configured to execute the instructions to:
obtain the registered product information; and
determine that the customer has the possibility of performing the fraudulent act when information regarding a product on which a scanning operation is performed by the hand of the customer is not registered in the registered product information.

17. The customer monitoring assistance device according to claim 15, wherein
the one or more processors are further configured to execute the instructions to:
obtain the accounting process information including information regarding a process displayed on the self-checkout terminal; and
determine that the customer is unfamiliar with the operation of the self-checkout terminal when the hand of the customer performs, on the self-checkout terminal, an operation different from an operation required for the process for equal to or more than a predetermined time.

18. A customer monitoring assistance method comprising:
obtaining a moving image obtained by capturing a movement of a hand of a customer who operates a self-checkout terminal;
determining whether the customer has a possibility of performing a fraudulent act or is unfamiliar with an operation of the self-checkout terminal based on the movement of the hand of the customer; and
outputting different content depending on a determination result.

19. A non-transitory recording medium storing a customer monitoring assistance device program for causing a computer to execute:
obtaining a moving image obtained by capturing a movement of a hand of a customer who operates a self-checkout terminal;
determining whether the customer has a possibility of performing a fraudulent act or is unfamiliar with an operation of the self-checkout terminal based on the movement of the hand of the customer; and
outputting different content depending on a determination result.
